(19) United States
(12) Patent Application Publication
(10) Pub. No.: US 2008/0170580 A1
(43) Pub. Date: Jul. 17, 2008

(54) Star network control with mesh network payload delivery

(76) Inventors: Stuart O. Goldman, Scottsdale, AZ (US); Richard E. Krock, Naperville, IL (US); Karl F. Rauscher, Emmaus, PA (US); James P. Runyon, Wheaton, IL (US)

Correspondence Address: FAY SHARPE/LUCENT, 1100 SUPERIOR AVE, SEVENTH FLOOR, CLEVELAND, OH, 44114, US

(21) Appl. No.: 11/654,333

(22) Filed: Jan. 17, 2007

(51) Int. Cl. H04L 12/56

(52) U.S. Cl. 370/406

(57) ABSTRACT

A network is provided that includes: a central node (30) and a plurality of other nodes (32); a plurality of first communication links (34) interconnecting the central node (30) to the plurality of other nodes (32) to form a star network topology; and, a plurality of second communication links (36) interconnecting the plurality of other nodes (32) to form a mesh network topology.

### FIELD

The present inventive subject matter relates to the art of network topologies. Particular application is found in conjunction with certain types of telecommunication networks, and the specification makes particular reference thereto. However, it is to be appreciated that aspects of the present inventive subject matter are also amenable to other like applications and/or networks.

### BACKGROUND

Network topology refers to the arrangement or mapping of network elements or nodes and the interconnections or communication links therebetween. In general, a wide variety of different network topologies are known in the art, e.g., as used in telecommunication and/or computer networks. One such network topology is known as a star network topology. An example of a conventional star network topology is shown in FIG. 1. The star network topology is characterized by a central node 10 or network element (commonly referred to as a hub), and one or more other nodes 12 (commonly referred to as spokes) that are each interconnected to or otherwise operatively in communication with the hub 10 via links 14. In a conventional star network topology, all data that is communicated between the nodes is transmitted through the hub 10. That is to say, the nodes (e.g., spokes 12) communicate with one another by passing data through the hub 10.

The star network topology has certain advantages. For example, if one of the links 14 fail, only the spoke 12 served by that link 14 is affected. The remaining spokes/nodes 12 may continue to communicate and/or exchange data with one another through the hub 10. However, the star network topology also has certain drawbacks. For example, if the hub 10 fails or partially fails, then the entire network goes down or is significantly crippled, i.e., none of the spokes 12 can communicate or exchange data with the others. Moreover, the hub 10 presents a potentially large security risk. For example, if security at the hub 10 is breached, then any communications or data being transmitted between the spokes 12 is potentially compromised because typically all such communications and/or data are transmitted through the hub 10. That is to say, the entire network may be compromised once the hub 10 is breached. Insomuch as the hub 10 is a central location through which all the data exchanged in the network must pass, the hub 10 can be an attractive target for hackers or other such unauthorized users attempting to intercept confidential or private communications or otherwise obtain sensitive data being transmitted over the network.

The star network topology shown in FIG. 1 is generally recognized as a centralized network configuration. Conversely, a mesh network topology represents a decentralized network configuration. FIG. 2 illustrates an example of a conventional mesh network topology, including various nodes 20 and links 24 therebetween. FIG. 2 shows an example of a partially connected mesh network topology, i.e., a topology in which some of the nodes 20 are interconnected or otherwise in operative communication with more than one other node 20 via links 24. Another type of mesh network topology is known as a fully connected mesh network topology. An example of a conventional fully connected mesh network topology is shown in FIG. 3. In a fully connected mesh network topology, every one of the nodes 20 is directly interconnected by a plurality of links 24 to every other one of the nodes 20 in the network. Accordingly, each node 20 may communicate and/or exchange data directly with every other node 20 within the network. Moreover, with a conventional fully connected mesh network topology, it is possible for data to be simultaneously transmitted from any single node 20 to all of the other nodes 20. However, it is at times impractical to provide the many links 24 that are employed in a fully connected mesh network topology. Accordingly, networks often employ the conventional partially connected mesh network topology as shown in FIG. 2. In either case, unlike the star network topology, a mesh network topology does not employ a central node or hub. Rather, communications and/or data are exchanged directly or indirectly between the nodes 20, e.g., employing the shortest route or fewest number of links 24 therebetween.

Of course, mesh network topologies have certain advantages, e.g., the redundancy of interconnections. That is to say, in a conventional mesh network topology, there are at least two nodes 20 with two or more paths between them to provide redundant paths to be used in case a link 24 providing one of the paths fails. This decentralized approach is often used to advantage to compensate for the single-point-failure disadvantage that is present, e.g., in a standard star network topology. However, mesh network topologies also have certain drawbacks. For examle, network control and/or communication routing and/or data or node validation can be more burdensome. That is to say, each node 20 carries the burden of having to maintain and/or support its own routing maps and/or logic, network configuration and/or address information, validation processing, etc. For example, this is because there is no central node or hub to handle all the data routing for the network. Rather, each individual node 20 of the network possesses the routing logic, network configuration information and/or address information to determine the correct path to use at any particular time to transmit data to the appropriate node or nodes 20 that are suppose to receive the data. Moreover, the routing logic and/or address information and/or network configuration information and the like at each node 20 has to be updated each time there is a change in the network. Such updating can be burdensome and/or time consuming, perhaps, leaving a node 20 with out-of-date information for some period of time.

Accordingly, a new and improved network topology and/or method for using the same is disclosed that overcomes the above-referenced problems and others.

### SUMMARY

In accordance with one embodiment, a network is provided that includes: a central node and a plurality of other nodes; a plurality of first communication links interconnecting the central node to the plurality of other nodes to form a star network topology; and, a plurality of second communication links interconnecting the plurality of other nodes to form a mesh network topology.

In accordance with another embodiment, a method for transmitting sensitive data within a network is provided. The method includes: providing a first node and a plurality of second nodes; providing a plurality of first communication links interconnecting the first node to the plurality of second nodes to form a star network topology with the first node as a hub and the second nodes as spokes; and, providing a plurality of second communication links interconnecting the plurality of second nodes to form a mesh network topology; wherein sensitive data transmitted between the seconds nodes is routed over the second links and not through the first node.

Numerous advantages and benefits of the inventive subject matter disclosed herein will become apparent to those of ordinary skill in the art upon reading and understanding the present specification.

### BRIEF DESCRIPTION OF THE DRAWINGS

The inventive subject matter may take form in various components and arrangements of components, and in various steps and arrangements of steps. The drawings are only for purposes of illustrating preferred embodiments and are not to be construed as limiting. Further, it is to be appreciated that the drawings are not to scale.

FIG. 1 is a diagram illustrating a conventional star network topology.

FIG. 2 is a diagram illustrating a conventional partially connected mesh network topology.

FIG. 3 is a diagram illustrating a conventional fully connected mesh network topology.

FIG. 4 is a diagram illustrating an exemplary network topology in accordance with and/or suitable for practicing aspects of the present inventive subject matter.

FIG. 5 is a diagram illustrating another exemplary network topology in accordance with and/or suitable for practicing aspects of the present inventive subject matter.

FIG. 6 is a flow chart illustrating an exemplary data transmission process employing a network topology such as the one shown in FIGS. 4 or 5.

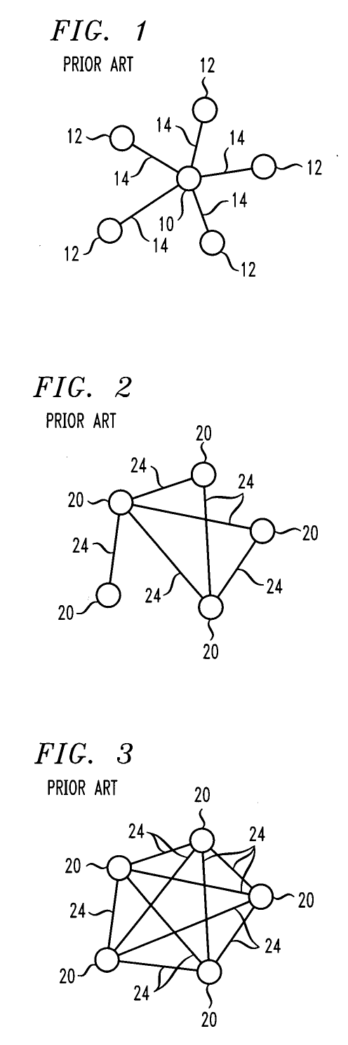

### DETAILED DESCRIPTION OF PREFERRED EMBODIMENTS

For clarity and simplicity, the present specification shall refer to structural and/or functional elements, entities and/or facilities, relevant communication standards, protocols and/or services, and other components that are commonly known in the telecommunications and/or networking arts without further detailed explanation as to their configuration or operation except to the extent they have been modified or altered in accordance with and/or to accommodate the preferred embodiment(s) presented herein.

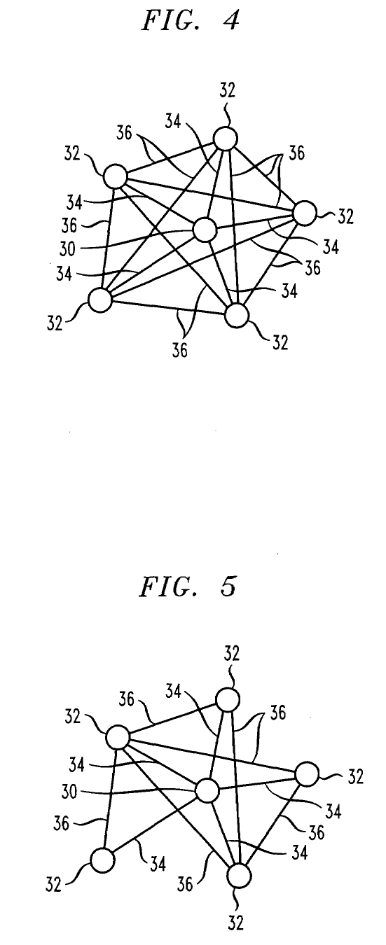

With reference to FIGS. 4 and 5, examples of network topologies are shown which are suitable for telecommunication, computer and/or other like networks. Each topology is a combination or hybrid of a star network topology and a mesh network topology. FIG. 4 illustrates a star network topology combined with a fully connected mesh network topology and FIG. 5 illustrates a star network topology combined with a partially connected mesh network topology. In either case, the combination of topologies as proposed herein provides a robust network that avoids the potential weaknesses and/or drawbacks associated with the conventional individual star and mesh network topologies when they are implemented alone.

Each of the network topologies shown in FIGS. 4 and 5 is characterized by a central node 30 or network element (referred to herein as a hub), and one or more other nodes 32 (referred to herein as spokes) that are each interconnected to or otherwise operatively in communication with the hub 10 via links 34. This represents the star network topology portion of the combination.

Additionally, as shown in FIG. 4, each of the spokes 32 is interconnected to or otherwise in operative communication which each of the other spokes 32 via links 36. This represents the fully connected mesh network topology portion of the combination. Also, as shown in FIG. 5, each of the spokes 32 are interconnected to or otherwise in operative communication which one or more of the other spokes 32 via links 36. This represents the partially connected mesh network topology portion of the combination.

Depending on the type of network, each node illustrated in the respective topology may represent a different network element. For example, in a telecommunications network, the nodes 30 and 32 are optionally telecommunication switches, such as SS7 (Signaling System 7) switches or other class five telecommunication switches (e.g., the 5ESS) or other hard or soft telecommunication switches, or other like telecommunication elements or facilities or combinations thereof. Alternately, in a computer network, the nodes 30 and 32 are optionally servers or computer workstations or the like.

The links 34 between the spokes 32 and the hub 30 and the links 36 between the spokes 34 have been separately identified herein for purposes of illustrating the respective portions of the combined network topologies. However, in practice, it is to be appreciated that optionally the links 34 and 36 are otherwise similar in nature and/or function. For example, each of the links 34 and 36 are optionally implemented via fixed wires or cabling, radio frequency (RF) or other wireless connections, or a combination thereof.

In a suitable embodiment, the proposed network topology (e.g., illustrated in FIGS. 4 and 5) protects sensitive or otherwise confidential information from delivery to a centralized point where it may be compromised, while still using a centralized point for administrative control. That is to say, the hub 30 provides a centralized point of administrative control, but does not actually receive any sensitive data. Rather, the sensitive data is only transmitted between the nodes 32 over the links 36, i.e., without having to be routed through the hub 30.

In general, the hub 30 is provisioned with and/or maintains a network map or network configuration information (especially as it relates to the sharing of sensitive information) and/or other like network administration information for the entire network. Accordingly, the individual spokes or nodes 32 are relieved of the burden of separately having to be provision with and/or maintain the foregoing for themselves. Suitably, the individual spokes or nodes 32 may be provisioned with network routing information about adjacent nodes but are not provisioned with a network map or network configuration information (especially as it relates to the sharing of sensitive information) or other like network administration information for the entire network.

Suitably, the network map or network configuration information maintained by the hub 30 identifies the different nodes 32 in the network and the links 36 therebetween, optionally, including information about the current validity and/or status of each. For example, the hub 30 is optionally provisioned with or otherwise includes: a table or other listing containing the addresses and optionally authentication information for each of the spokes or nodes 32 in the network; routing logic to determine which nodes 32 are to receive the actual data or information when one of the nodes 32 has such a payload to deliver and which path (i.e., link 36 or series of links 36) the payload should take; and other like administrative information and/or functions. Suitably, the status information regarding the nodes 32 and the links 36 identifies, e.g., which ones are active or live or otherwise valid and/or functioning properly and which ones are inactive or down or otherwise invalid and/or malfunctioning. Accordingly, the hub 30 can make payload routing determinations as appropriate for given circumstances.

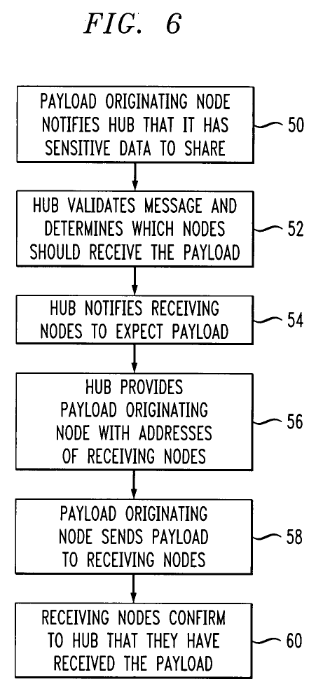

With reference to FIG. 6, an exemplary data transfer operation of a network having one of the topologies shown in FIGS. 4 or 5 will now be described. For purposes of the present description, it shall be assumed that a node 32 (referred to herein as the payload originating node) has sensitive data or confidential information or some other payload that it desires to share with other nodes 32 in the network.

For example, the payload originating node 32 may be experiencing a particular condition or other circumstances that warrant sharing sensitive data or confidential information with other nodes 32 in the network. Such a condition may be, e.g., a security breach at the payload originating node 32. In the case of a telecommunications network, for example, the payload originating node 32 may be experiencing a denial of service attack or other security condition. Accordingly, the originating node 32 may have sensitive data or confidential information that should be shared with other nodes 32 in the network so that they can protect themselves against a similar attack or security breach. For example, the confidential information or sensitive data may identify the source of the attack, a weakness in security that enabled the attack, a bug or error that was exploited to perpetrate the attack, etc. Of course, this is information that could pose additional security risks and/or thwart corrective measures if it were to be obtained by the perpetrators of the attack or other unauthorized persons.

In any event, at step 50, when the payload originating node 32 has sensitive data or confidential information or some other payload that it desires to share with other nodes 32 in the network, the payload originating node 32 sends a message or signal to the hub 30 via the appropriate link 34 notifying the hub 30 of the nature and/or type of information that it has to share. That is to say, the message or signal sent to the hub 30 identifies the nature or type or category of the information. However, the actual data or information contained in the payload which is to be shared with the other nodes 32 in the network is not sent to the hub 30. Accordingly, the sensitive data or confidential information is not made available to the hub 30 where it may be potentially compromised or exposed to additional vulnerabilities. Rather, the hub 30 is merely informed as to the nature or type or category of the information that the payload originating node 32 desires to share. For example, to continue with the previous example, the notification sent to the hub 30 may merely indicate that the originating node 32 desires to share information relating to a particular security condition that it is experiencing without providing the particular information about the security condition that is to be shared with the other nodes 32.

At step 52, the hub 30 verifies the message or signal received from the payload originating node 32 in step 50, and based upon the nature or type or category of the payload information as indicated in the message or signal, the hub 30 determines which of the other nodes 32 in the network should receive the payload. For purposes herein, these other nodes 32 identified by the hub 30 shall be referred to as receiving nodes. Optionally, one or more nodes 32 may be identified by the hub 30 as the nodes 32 that are supposed to receive the payload. Suitably, the particular receiving nodes 32 are selected by the hub 30 based upon: (i) the nature or type of payload information indicated in the message or signal received by the hub 30 in step 50; and/or, (ii) the identity of the payload originating node 32.

At step 54, the hub 30 notifies the identified receiving nodes 32 to expect the payload from the payload originating node 32. For example, this notification optionally takes the form of a message or signal sent from the hub 30 to the identified receiving nodes 32 via appropriate links 34. Suitably, the message or signal sent by the hub 30 to the receiving nodes 32 in step 54 specifies not only which node the receiving node 32 is to expect the payload from, but also the nature or type or category of information to expect in the payload. Optionally, the message or signal sent by the hub 30 to the receiving nodes 32 in step 54 also specifies a time frame in which the receiving node 32 should expect to receive the payload from the payload originating node 32. Additionally, the message or signal sent by the hub 30 to the receiving nodes 32 in step 54 also specifies a unique key or code or other authentication credentials that the receiving node 32 should expect to receive along with the payload from the payload originating node 32. In this manner, the receiving nodes 32 can determine accordingly if any payload information received conforms to what they are expecting (i.e., the correct type of data, received from the appropriate node, within the specified time frame and including the proper authentication credentials). If it does, then the receiving nodes 32 have a level of confidence that the payload information is valid or authentic, otherwise if a received payload does not conform to what is expected, the receiving nodes 32 can treat the payload information as invalid or suspect.

At step 56, the addresses and/or other routing information for the receiving nodes 32 identified by the hub 30 are provided by the hub 30 to the payload originating node 32, e.g., via the appropriate link 34. Optionally, along with the routing information and/or addresses, the hub 30 also provides the payload originating node 32 with the proper authentication credentials that are to be included with the payload when it is delivered. In this manner, the payload originating node 32 is made aware of how and/or where to deliver the payload and what authentication credentials to use when transmitting the payload. In accordance with the addresses and/or routing information received from the hub 30, at step 58, the payload originating node 32 sends or otherwise transmits individual messages or signals containing the payload (and optionally any appropriate authentication credentials) to the receiving nodes 32, e.g., via the appropriate links 36. That is to say, suitably, the sensitive data or confidential information or payload is delivered over the mesh portion of the network topology rather than through the hub 30.

Finally, at step 60, the receiving nodes 32 confirm to the hub 30 that they have received the payload conforming to what was expected. Suitably, the confirmation takes the form of a message or signal sent from the receiving nodes 32 to the hub 30, e.g., via the appropriate links 34. In this manner, the hub 30 is made aware of the completion of the payload transmission to the appropriate receiving nodes 32. Of course, the foregoing description assumes that the payload delivery is properly completed and/or administered. However, if the payload or any of the signals or messages do not get properly delivery or are not properly received and/or acted upon in the appropriate fashion, then suitable detection and/or recovery process or operations are optionally implemented.

It is to be appreciated that in connection with the particular exemplary embodiments presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A network comprising:
a central node and a plurality of other nodes;
a plurality of first communication links interconnecting the central node to the plurality of other nodes to form a star network topology; and,
a plurality of second communication links interconnecting the plurality of other nodes to form a mesh network topology.

2. The network of claim 1, wherein the plurality of second links are arranged such that the mesh network topology comprises a fully connected mesh network topology.

3. The network of claim 1, wherein the plurality of second links are arranged such that the mesh network topology comprises a partially connected mesh network topology.

4. The network of claim 1, wherein the central node is provisioned with network configuration information for the entire network and the plurality of second nodes are not provisioned with network configuration information for the entire network.

5. The network of claim 1, wherein the central node provides administrative control for data transmissions between the plurality of other nodes, said data transmissions being routed between the respective other nodes via the second links and not through the central node.

6. The network of claim 5, wherein when one of the other nodes has data that is to be share it notifies the central node of the type of data via one of the first links interconnecting the central node with the other node that has the data to be shared.

7. The network of claim 6, wherein upon receiving the notification, the central node identifies which of the other nodes are to receive the data and via the first links alerts the identified other nodes to expect the data.

8. The network of claim 7, wherein the alert provided to the identified other nodes by the central node indicates which one of the other nodes the data is coming from.

9. The network of claim 7, wherein the alert provided to the identified other nodes by the central node indicates the type of data is to be expected by the identified other nodes.

10. The network of claim 7, wherein the alert provided to the identified other nodes by the central node indicates a time frame in which the data is to be expected by the identified other nodes.

11. The network of claim 7, wherein the central node provides at least one of routing instructions and address information to the other node which has the data to be share.

12. The network of claim 11, wherein the other node having the data to be shared transmits said data via the second links to the identified other nodes in accordance with at least one of the routing instructions and the address information received from the central node.

13. The network of claim 12, wherein upon receiving the data, the other nodes confirm the same to central node via the first links.

14. A method for transmitting sensitive data within a network, said method comprising:
(a) providing a first node and a plurality of second nodes;
(b) providing a plurality of first communication links interconnecting the first node to the plurality of second nodes to form a star network topology with the first node as a hub and the second nodes as spokes; and,
(c) providing a plurality of second communication links interconnecting the plurality of second nodes to form a mesh network topology;
wherein sensitive data transmitted between the seconds nodes is routed over the second links and not through the first node.

15. The method of claim 14, further comprising:
(d) notifying the first node when one of the second nodes has sensitive data that is to be share with other second nodes, said notification being provided from the one second node to the first node via the first link interconnecting the one second node with the first node and said notification indicating a nature of the sensitive data but not including the sensitive data itself.

16. The method of claim 15, further comprising:
(e) identifying which other second nodes should receive the sensitive data, said identifying being performed by said first node in response to receiving said notification from step (d).

17. The method of claim 16, further comprising:
(f) alerting the identified second nodes to expect the sensitive data, said alert being provided by the first node to the identified second nodes via the first links interconnecting said identified second nodes with said first node.

18. The method of claim 17, further comprising:
(g) supplying at least one of routing instructions and address information to said one second node, said supplying being performed by the first node via the first link interconnecting said one second node with said first node.

19. The method of claim 18, further comprising:
(h) transmitting said sensitive data in accordance with at least one of the routing instructions and the address information, said sensitive data being transmitted from said one second node to the other identified second nodes via the second links interconnecting the second nodes with one another.

20. The method of claim 19, further comprising:
(i) confirming receipt of said sensitive data, said confirmation being provided to the first node from the identified second nodes via the first links interconnecting the identified second nodes with the first node.
